(19) United States
(12) Patent Application Publication
(10) Pub. No.: US 2025/0218284 A1
(43) Pub. Date: Jul. 3, 2025

(54) ROADSIDE DEVICE, METHOD, AND CONTROL SYSTEM

(71) Applicant: TOYOTA JIDOSHA KABUSHIKI KAISHA, Toyota-shi Aichi-ken (JP)

(72) Inventors: Toshiki KASHIWAKURA, Ota-ku Tokyo (JP); Chihiro INABA, Nerima-ku Tokyo (JP); Shoi SUZUKI, Ota-ku Tokyo (JP); Tsuyoshi OKADA, Nagoya-shi Aichi-ken (JP); Yasuhiro KOBATAKE, Nagoya-shi Aichi-ken (JP)

(73) Assignee: TOYOTA JIDOSHA KABUSHIKI KAISHA, Toyota-shi Aichi-ken (JP)

(21) Appl. No.: 18/950,741

(22) Filed: Nov. 18, 2024

(30) Foreign Application Priority Data
Dec. 28, 2023 (JP) 2023-223354

(51) Int. Cl. G08G 1/005; B60Q 7/00; G08G 1/01

(52) U.S. Cl. CPC G08G 1/005; B60Q 7/005; G08G 1/0116; G08G 1/0125; G08G 1/0141

(57) ABSTRACT

A roadside device includes a communication unit, a shooting unit, a notification unit, and a control unit. The control unit is configured to, when a pedestrian heading toward a roadway is detected from video shot by the shooting unit, perform notification the pedestrian of first information based on conditions of the roadway via the notification unit. Also, the control unit is configured to, after the notification of the first information, notify a driving assistant of a relevant vehicle, that is an automated driving vehicle approaching the roadside device, of second information via the communication unit. The first information is information indicating that the roadway is crossable. The second information is information indicating presence of the pedestrian.

### CROSS-REFERENCE TO RELATED APPLICATION

This application claims priority to Japanese Patent Application No. 2023-223354 filed on Dec. 28, 2023, incorporated herein by reference in its entirety.

### BACKGROUND

### 1. Technical Field

The present disclosure relates to a roadside device, a method, and a control system.

### 2. Description of Related Art

There is technology for providing assistance of traffic information to relevant individual such as pedestrians, vehicle drivers, driving assistants, and so forth, for example. Japanese Unexamined Patent Application Publication No. 2023-050629 (JP 2023-050629 A), for example, discloses an annunciation system that, in accordance with behavior of an automated driving vehicle that is scheduled to pass through a predetermined traffic region, performs annunciation to vehicles other than this automated driving vehicle, pedestrians, or the like, of information regarding whether a road is open, points to which attention should be paid, and so forth.

### SUMMARY

Improvement is desired in technology for providing traffic information assistance to relevant individuals.

The present disclosure has been made taking into consideration such circumstances, and provides technology for providing traffic information assistance to a relevant individual.

A first aspect of the present disclosure is a roadside device. The roadside device includes a communication unit, a shooting unit, a notification unit, and a control unit. The control unit is configured to notify a pedestrian of first information based on conditions of a roadway, via the notification unit, when the pedestrian heading toward the roadway is detected from video of the shooting unit. Also, the control unit is configured to, after the notification of the first information, notify second information to a driving assistant of a relevant vehicle, that is an automated driving vehicle approaching the roadside device, via the communication unit. The first information is information indicating that the roadway is crossable. The second information is information indicating presence of the pedestrian.

In the roadside device according to the first aspect of the present disclosure, the control unit may be configured to, upon detecting the pedestrian from the video, notify the pedestrian of the first information, when a predetermined automated driving vehicle is not present on the roadway. The predetermined automated driving vehicle may be a vehicle of which remaining time until passing the roadside device is less than a first threshold value.

In the roadside device according to the first aspect of the present disclosure, the control unit may be configured to notify the pedestrian of third information via the notification unit when the predetermined automated driving vehicle is present on the roadway. The third information may be information indicating constraints regarding crossing the roadway.

In the roadside device according to the first aspect of the present disclosure, the control unit may be configured to monitoring the remaining time for each automated driving vehicle approaching the roadside device. The control unit may, when the remaining time for an automated driving vehicle reaches a second threshold value that is less than the first threshold value, decide the automated driving vehicle to be the relevant vehicle.

In the roadside device according to the first aspect of the present disclosure, the control unit may estimate a traveling route of the automated driving vehicle, based on changes in positions of the automated driving vehicles present on the roadway, and map information. The control unit may monitor the remaining time for each automated driving vehicle regarding which the roadside device is installed on the traveling route.

In the roadside device according to the first aspect of the present disclosure, the control unit may be configured to acquire information indicating a traveling route of each automated driving vehicle present on the roadway from an information processing device via the communication unit. The control unit may be configured to monitor the remaining time for each automated driving vehicle regarding which the roadside device is installed on the traveling route.

In the roadside device according to the first aspect of the present disclosure, the control unit may be configured to transmit a request for acquiring fourth information to the information processing device via the communication unit, when the pedestrian is detected from the video. The control unit may be configured to receive the fourth information from the information processing device via the communication unit. The fourth information may be information indicating whether the predetermined automated driving vehicle is present on the roadway.

A second aspect of the present disclosure is a method executed by a roadside device including a communication unit, a shooting unit, and a notification unit. The method includes notifying a pedestrian of first information based on conditions of a roadway, via the notification unit, when the pedestrian heading toward the roadway is detected from video of the shooting unit; and after the notification of the first information, notifying second information to a driving assistant of a relevant vehicle, that is an automated driving vehicle approaching the roadside device, via the communication unit. The first information is information indicating that the roadway is crossable. The second information is information indicating presence of the pedestrian.

In the method according to the second aspect of the present disclosure, upon the pedestrian being detected from the video, the roadside device may notify the pedestrian of the first information when a predetermined automated driving vehicle is not present on the roadway. The predetermined automated driving vehicle may be a vehicle of which remaining time until passing the roadside device is less than a first threshold value.

The method according to the second aspect of the present disclosure may further include notifying third information to the pedestrian via the notification unit when the predetermined automated driving vehicle is present on the roadway. The third information may be information indicating constraints regarding crossing the roadway.

The method according to the second aspect of the present disclosure may further include monitoring the remaining time for each automated driving vehicle approaching the roadside device, and deciding an automated driving vehicle to be the relevant vehicle when the remaining time for the automated driving vehicle reaches a second threshold value that is less than the first threshold value.

The method according to the second aspect of the present disclosure may further include estimating a traveling route of the automated driving vehicle, based on changes in positions of the automated driving vehicles present on the roadway, and map information, and monitoring, by the roadside device, the remaining time for each automated driving vehicle regarding which the roadside device is installed on the traveling route.

The method according to the second aspect of the present disclosure may further include acquiring information indicating the traveling route of each automated driving vehicle present on the roadway from an information processing device via the communication unit, and monitoring, by the roadside device, the remaining time for each automated driving vehicle regarding which the roadside device is installed on the traveling route.

The method according to the second aspect of the present disclosure may further include transmitting a request for acquisition of information indicating whether the predetermined automated driving vehicle is present on the roadway, to an information processing device via the communication unit, when the pedestrian is detected from the video; and receiving the information from the information processing device via the communication unit.

A third aspect of the present disclosure is a control system. The control system includes a roadside device including a shooting unit and a notification unit, and an information processing device that is communicable with the roadside device. The roadside device is configured to notify a pedestrian of first information via the notification unit, based on conditions of a roadway, when the pedestrian heading toward the roadway is detected from video of the shooting unit. The roadside device is configured to, after the notification of the first information, notify second information to a driving assistant of a relevant vehicle, that is an automated driving vehicle approaching the roadside device, via the information processing device. The first information is information indicating that the roadway is crossable. The second information is information indicating presence of the pedestrian.

In the control system according to the third aspect of the present disclosure, the roadside device may be configured to, upon detecting the pedestrian from the video, notify the pedestrian of the first information, when a predetermined automated driving vehicle is not present on the roadway. The predetermined automated driving vehicle may be a vehicle of which remaining time until passing the roadside device is less than a first threshold value.

In the control system according to the third aspect of the present disclosure, the roadside device may be configured to notify the pedestrian of third information via the notification unit when the predetermined automated driving vehicle is present on the roadway. The third information may be information indicating constraints regarding crossing the roadway.

In the control system according to the third aspect of the present disclosure, the roadside device or the information processing device may be configured to monitor the remaining time for each automated driving vehicle approaching the roadside device. The roadside device or the information processing device may be configured to, when the remaining time for an automated driving vehicle reaches a second threshold value that is less than the first threshold value, decide the automated driving vehicle to be the relevant vehicle.

In the control system according to the third aspect of the present disclosure, the roadside device or the information processing device may be configured to estimate a traveling route of the automated driving vehicle, based on changes in positions of the automated driving vehicles present on the roadway, and map information. The roadside device or the information processing device may be configured to monitor the remaining time for each automated driving vehicle regarding which the roadside device is installed on the traveling route.

In the control system according to the third aspect of the present disclosure, the roadside device may be configured to transmit a request for acquiring fourth information to the information processing device, when the pedestrian is detected from the video. The information processing device may be configured to transmit the information to the roadside device in response to receiving the acquisition request. The fourth information may be information indicating whether the predetermined automated driving vehicle is present on the roadway.

According to an embodiment of the present disclosure, technology for providing traffic information assistance to a relevant individual is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a vehicle;

FIG. 3 is a block diagram illustrating a schematic configuration of a roadside device;

FIG. 4 is a block diagram illustrating a schematic configuration of an information processing device;

FIG. 5 is a flowchart showing operations of the roadside device according to the embodiment; and

FIG. 6 is a sequence diagram showing operations of a system according to another embodiment.

### DETAILED DESCRIPTION OF EMBODIMENTS

An embodiment of the present disclosure will be described below.

### Overview of Embodiment

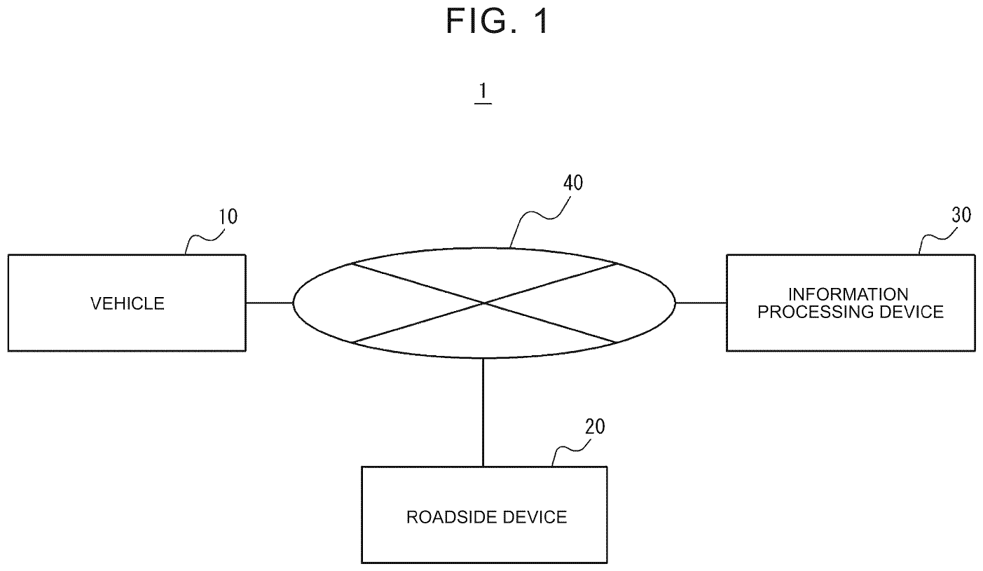

An outline of a system 1 according to an embodiment of the present disclosure will be described with reference to FIG. 1. The system 1 includes a vehicle 10, a roadside device 20, and an information processing device 30. The vehicle 10, the roadside device 20, and the information processing device 30 are connected to a network 40, including a mobile communication network, the Internet, and so forth, for example, so as to be communicable with each other.

The vehicle 10 is, for example, a gasoline vehicle, a battery electric vehicle (BEV), a hybrid electric vehicle (HEV), a plug-in hybrid electric vehicle (PHEV), a fuel cell electric vehicle (FCEV), or the like, but the vehicle 10 is not limited to these, and may be any vehicle which a person can board. For example, the vehicle 10 may be an automated driving vehicle that is able to be driven at Levels 1 to 5 of automated driving as defined by the Society of Automotive Engineers (SAE), or the like. In the present embodiment, the vehicle 10 is capable of Level 3 or 4 automated driving, and a driving assistant can override driving operations riding onboard the vehicle 10, or remotely. The system 1 may include any number of vehicles 10 that is one or more.

The roadside device 20 is installed near an intersection, a pedestrian crossing, or the like, for example. In the present embodiment, the roadside device 20 can detect, from video shot by a camera installed therein, a pedestrian heading toward the roadway, as a pedestrian intending to cross the roadway. Also, upon detecting a pedestrian intending to cross the roadway, the roadside device 20 provides traffic information assistance, by notifying the pedestrian and a driver or the driving assistant of the vehicle 10 approaching the roadside device 20, of predetermined information. The system 1 may include any number of roadside devices 20 that is one or more.

The information processing device 30 is one or more computers communicable with each other. The information processing device 30 is communicable with each vehicle 10 and each roadside device 20 via the network 40. In the present embodiment, communication between the vehicle 10 and the roadside device 20 may be performed via the information processing device 30. The information processing device 30 also communicates with each vehicle 10, and continuously acquires vehicle information including, for example, the position of the vehicles 10 and so forth.

An overview of the present embodiment will be described first, and details thereof will be described later. When a pedestrian heading toward the roadway is detected, the roadside device 20 notifies the pedestrian of first information indicating that the pedestrian can cross the roadway, based on the conditions of the roadway. After notification of the first information, the roadside device 20 then notifies the driving assistant of a relevant vehicle 10, which is the vehicle 10 approaching itself (the roadside device 20), of second information indicating presence of the pedestrian.

According to the present embodiment, the second information indicating the presence of the pedestrian is notified to the driving assistant after a timing of the first information indicating that the pedestrian can cross the roadway being notified to the pedestrian. This increases the certainty that the driving assistant will pay attention to the presence of the pedestrian intending to cross the roadway, which will be explained below.

Generally, automated driving vehicles are designed to perform automated driving while giving pedestrians the right-of-way, and from a safety standpoint, an override function is also employed to allow the vehicle to be driven manually by a driving assistant onboard or remotely, as described above. However, in a situation in which, for example, a pedestrian begins to cross the roadway from a blind spot of the automated driving vehicle, or the like, there are cases in which both the automated driving vehicle and the driving assistant are unable to recognize the presence of the pedestrian, or recognition is delayed.

On the other hand, a situation will be considered in which, when a pedestrian heading towards the roadway is detected, for example, an optional notification is given to both the pedestrian and the driving assistant. For example, when a notification is given to a pedestrian at a timing when there is sufficient time remaining before the automated driving vehicle passes the roadside device 20, this notification can act as a “green light”, so to speak, indicating to the pedestrian that the roadway can be crossed. Now, assuming an example in which notifications are sent simultaneously to pedestrians and to the driving assistant of the automated driving vehicle, the notification to the driving assistant can similarly act as a “green light” indicating to the driving assistant that it is safe to pass the roadside device 20.

However, in this example, giving consideration unforeseen circumstances such as a pedestrian stumbling while crossing the roadway or a pedestrian starting to cross the road some time after the pedestrian being notified, or the like, the driving assistant may determine that “the roadside device 20 can be safely passed” at a timing when there is sufficient time remaining before the automated driving vehicle passes the roadside device 20, which may result in not paying sufficient attention thereafter. In other words, in this example in which notifications are made simultaneously to pedestrians and to the driving assistant, the timing of the notification being made to the driving assistant is too early, which may result in the driving assistant not paying sufficient attention thereafter.

Conversely, according to the present embodiment, the second information indicating presence of a pedestrian is notified to the driving assistant after the timing at which the first information indicating that the roadway can be crossed is notified to the pedestrian (i.e., the timing at which there is sufficient time remaining before the automated driving vehicle passes the roadside device 20), as described above. Thus, the present embodiment improves the technology for providing traffic information assistance to relevant individuals with respect to the point that the certainty that the driving assistant will pay attention to the presence of a pedestrian attempting to cross the roadway is increased.

Next, the configurations of the system 1 will be described in detail.

### Configuration of Vehicle

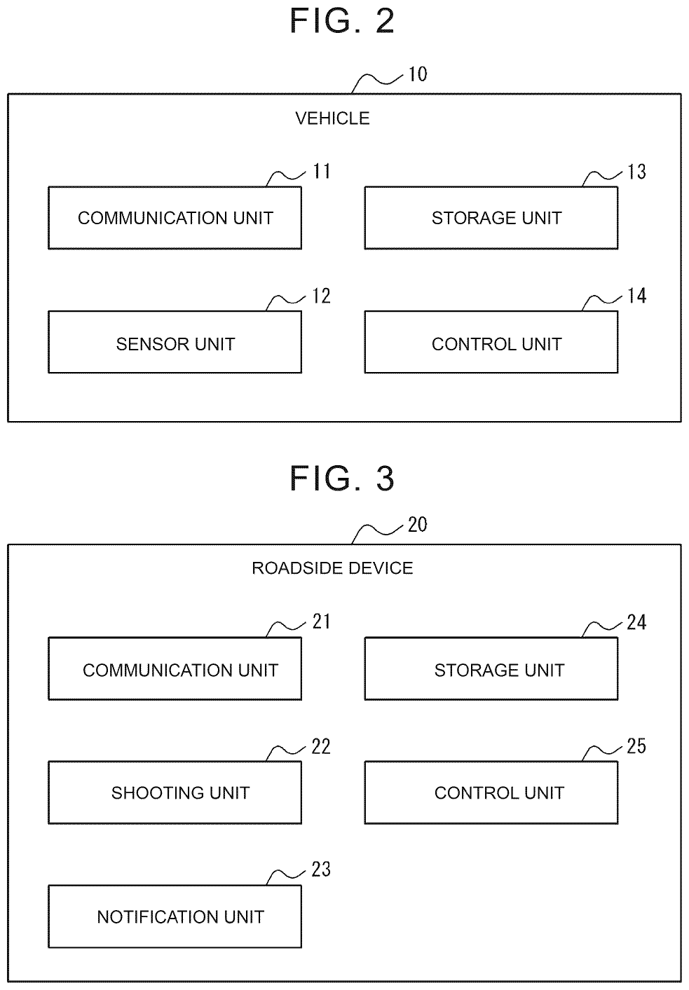

As illustrated in FIG. 2, the vehicle 10 includes a communication unit 11, a sensor unit 12, a storage unit 13, and a control unit 14.

The communication unit 11 includes one or more communication interfaces for connecting to the network 40. The communication interface supports, for example, 4th generation (4G) and 5th generation (5G) mobile communication standards, but this is not restrictive, and the communication interface may support any communication standard. In the present embodiment, the vehicle 10 communicates with the information processing device 30 via the communication unit 11 and the network 40.

The sensor unit 12 includes one or more sensors used to control the vehicle 10. The sensor is, for example, a positioning sensor conforming to the Global Positioning System (GPS) or the like, a geomagnetic sensor, a speed sensor, an acceleration sensor, a gyro sensor, or the like, but is not limited to these and may be any sensor.

The storage unit 13 includes one or more memory devices. In the present embodiment, “memory” refers to, for example, semiconductor memory, magnetic memory, optical memory, or the like, but is not limited to such memory. Each memory device included in the storage unit 13 may function as, for example, a main storage device, an auxiliary storage device, or cache memory. The storage unit 13 stores optional information to be used for operations of the vehicle 10. For example, the storage unit 13 may store a system program, an application program, embedded software, and so forth. The information stored in the storage unit 13 may be updatable by information acquired from the network 40 via the communication unit 11, for example.

The control unit 14 includes one or more processors, one or more programmable circuits, one or more dedicated circuits, or a combination thereof. The processor may be, but is not limited to, a general-purpose processor such as a central processing unit (CPU), a graphics processing unit (GPU), or the like, or a dedicated processor specialized for specific processing, for example. The programmable circuit may be, but is not limited to, a field-programmable gate array (FPGA), for example. The dedicated circuit may be, but is not limited to, an application specific integrated circuit (ASIC), for example. The control unit 14 controls the operations of the entire vehicle 10.

For example, in the present embodiment, the control unit 14 transmits position information of the vehicle detected by the sensor unit 12 to the information processing device 30 via the communication unit 11. Transmission of the position information may be performed periodically, or whenever a predetermined event occurs, for example. Also, when traveling by following route information indicating a traveling route that has been searched and found, for example, the control unit 14 may transmit this route information to the information processing device 30.

### Configuration of Roadside Device

As illustrated in FIG. 3, the roadside device 20 includes a communication unit 21, a shooting unit 22, a notification unit 23, a storage unit 24, and a control unit 25.

The communication unit 21 includes one or more communication interfaces for connecting to the network 40. The communication interface supports a mobile communication standard or a wireless local area network (LAN) standard, for example, but is not limited thereto, and may support any communication standard. In the present embodiment, the roadside device 20 communicates with the information processing device 30 via the communication unit 21 and the network 40.

The shooting unit 22 includes one or more cameras capable of shooting nearby scenery. In the present embodiment, the roadside device 20 is installed near a boundary between the sidewalk and the roadway, for example, such that the shooting unit 22 can shoot video of a pedestrian moving from the sidewalk towards the roadway.

The notification unit 23 includes one or more notification devices that notify nearby pedestrians of information. The notification device is, for example, a speaker, electronic signage, a display, or the like, but is not limited to these and may be any notification device.

The storage unit 24 includes one or more memory devices. Each memory device included in the storage unit 24 may function as, for example, a main storage device, an auxiliary storage device, or cache memory. The storage unit 24 stores optional information that is to be used for operations of the roadside device 20. For example, the storage unit 24 may store system programs, application programs, embedded software, map information, and so forth. The information stored in the storage unit 24 may be updatable with information acquired from the network 40 via the communication unit 21, for example.

The control unit 25 includes one or more processors, one or more programmable circuits, one or more dedicated circuits, or a combination thereof. The control unit 25 controls the operations of the entire roadside device 20. The operations of the roadside device 20 will be described in detail later.

### Configuration of Information Processing Device

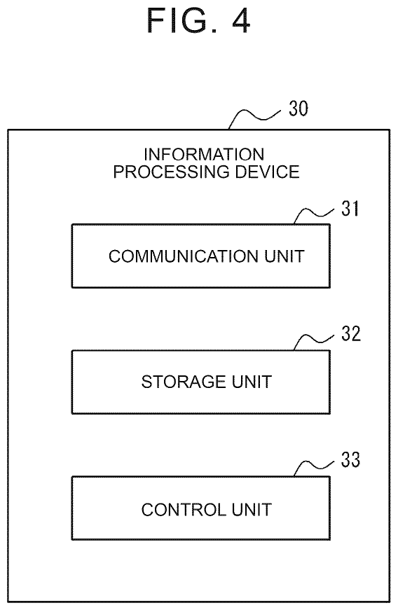

As illustrated in FIG. 4, the information processing device 30 includes a communication unit 31, a storage unit 32, and a control unit 33.

The communication unit 31 includes one or more communication interfaces for connecting to the network 40. These communication interfaces support a wired LAN standard or a wireless LAN standard, for example, but is not limited to these, and may support any communication standard. In the present embodiment, the information processing device 30 communicates with each of the vehicle 10 and the roadside device 20 via the communication unit 31 and the network 40.

The storage unit 32 includes one or more memory devices. Each memory device included in the storage unit 32 may function as, for example, a main storage device, an auxiliary storage device, or cache memory. The storage unit 32 stores optional information that is used for operations of the information processing device 30. For example, the storage unit 32 may store system programs, application programs, embedded software, map information, and so forth. In the present embodiment, the storage unit 32 stores information indicating positions at which each of the roadside devices 20 is installed.

The control unit 33 includes one or more processors, one or more programmable circuits, one or more dedicated circuits, or a combination thereof. The control unit 33 controls the operations of the entire information processing device 30. The operations of the information processing device 30 will be described in detail later.

### Operation Flow of Roadside Device

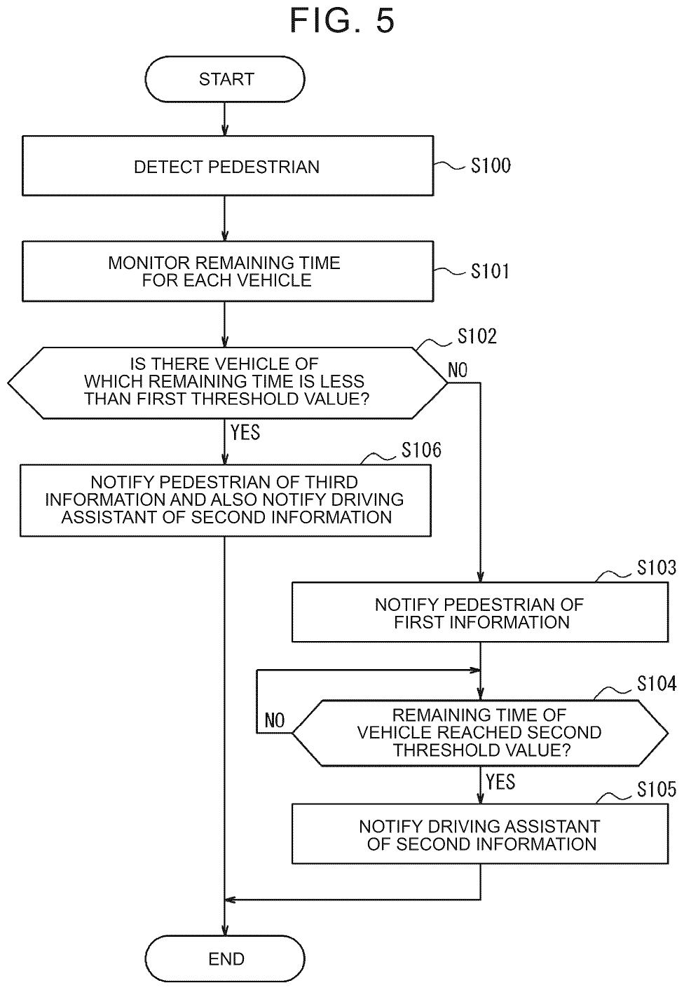

An operation flow of the roadside device 20 according to the present embodiment will be described with reference to FIG. 5.

In S100, the control unit 25 of the roadside device 20 detects, from video shot by the shooting unit 22, a pedestrian heading toward the roadway.

Specifically, the control unit 25 detects the pedestrian in the video by optional object recognition processing, and also identifies a direction of movement of the pedestrian from the change in position thereof. For example, the control unit 25 detects a pedestrian moving towards the roadway in the video as being a pedestrian intending to cross the roadway.

In S101, the control unit 25 monitors the remaining time until each vehicle 10 approaching itself (the roadside device 20) passes the roadside device 20.

In detail, first, the control unit 25 transmits a request to the information processing device 30 via the communication unit 21, to acquire position information of each vehicle 10. The control unit 25 receives, via the communication unit 21, the position information of each vehicle 10 that is continuously transmitted from the information processing device 30 in response to the acquisition request.

Next, the control unit 25 estimates the traveling route of each vehicle 10, based on the change in position of each vehicle 10 and the map information stored in the storage unit 24. Alternatively, the control unit 25 may transmit a request to acquire a traveling route of each vehicle 10 to the information processing device 30, and receive information indicating the traveling route of each vehicle 10 from the information processing device 30.

Next, the control unit 25 identifies each vehicle 10 regarding which it (the roadside device 20) is installed on the traveling route thereof, as each vehicle 10 approaching itself (the roadside device 20). The control unit 25 then continuously estimates the remaining time until each vehicle 10 passes the roadside device 20, based on the change in the position of each vehicle 10 that is identified, thereby monitoring the remaining time for each vehicle 10.

In S102, the control unit 25 determines whether there is at least one vehicle 10 of which the remaining time is less than a predetermined first threshold value. When determination is made that there is at least one vehicle 10 of which the remaining time is less than the first threshold value (Yes in S102), the process advances to S106. On the other hand, when determination is made that there is no vehicle 10 of which the remaining time is less than the first threshold value (in other words, the remaining time for all vehicles 10 is no less than the first threshold) (No in S102), the processing advances to S103.

The “first threshold value” is, for example, 60 seconds, but is not limited thereto, and may be any time period that conceivably allows a pedestrian to cross the roadway with leeway.

When determination is made in S102 that there is no vehicle 10 of which the remaining time is less than the first threshold value (No in S102), in S103 the control unit 25 notifies the pedestrian via the notification unit 23 of the first information indicating that the roadway can be crossed.

Specifically, the control unit 25 outputs the first information via a display or a speaker of the notification unit 23, thereby notifying the pedestrian of the first information. Here, “there is no vehicle 10 of which the remaining time is less than the first threshold value” suggests a situation in which there is sufficient time before the vehicle 10 approaching the roadside device 20 passes by the roadside device 20. Accordingly, a pedestrian who receives notification of the first information can recognize that this is the situation, and also that his or her presence has been correctly detected by the system 1 side, and accordingly it is safe to cross the roadway.

In S104, the control unit 25 determines whether the remaining time for the vehicle 10 has reached the second threshold value that is less than the first threshold value. When determination is made that the remaining time for the vehicle 10 has reached the second threshold value (Yes in S104), the processing advances to S105. On the other hand, when determination is made that the remaining time for the vehicle 10 is greater than the second threshold value (No in S104), the processing repeats S104.

The “second threshold value” may be, for example, 30 seconds, but is not limited to this, and may be any time period that is considered to be adequate to enable the driving assistant to maintain the level of attention that is required for traffic safety, until the vehicle 10 passes the roadside device 20. Hereinafter, the vehicle 10 regarding which determination is made that the remaining time has reached the second threshold value will also be referred to as “relevant vehicle 10”.

When determination is made in S104 that the remaining time for the vehicle 10 has reached the second threshold value (Yes in S104), in S105 the control unit 25 notifies the driving assistant of the relevant vehicle 10, which is the vehicle 10 approaching itself (the roadside device 20), of the second information indicating the presence of a pedestrian, via the communication unit 21.

Specifically, the control unit 25 notifies the driving assistant of the relevant vehicle 10 of the second information, by sending, to the information processing device 30 via the communication unit 21, a request for notification of the second information to the driving assistant. In response to receiving the notification request, the control unit 33 of the information processing device 30 notifies the driving assistant of the second information by transmitting the second information to the relevant vehicle 10, or a terminal device used by the driving assistant. That is to say, in the present embodiment, the roadside device 20 and the information processing device 30 cooperate to notify the driving assistant of the relevant vehicle 10 of the second information.

In this way, notification of the second information is performed when the remaining time for the vehicle 10 reaches the second threshold value, thereby increasing the likelihood that the driving assistant will be able to maintain the level of attention required for traffic safety until the vehicle 10 passes the roadside device 20.

When determination is made in S106 that there is at least one vehicle 10 regarding which the remaining time in S102 is less than the first threshold value (Yes in S102), the control unit 25 notifies the pedestrian of the third information indicating constraints regarding crossing the roadway, via the notification unit 23, and at the same time notifies the driving assistant of each vehicle 10 regarding which the remaining time is less than the first threshold value, of the above second information.

Specifically, the control unit 25 outputs the first information via the display or the speaker of the notification unit 23, thereby notifying the pedestrian of the first information. Here, the “third information” includes, but is not limited to, a message such as, for example, “The automated driving vehicle will come to a stop to give right-of-way to pedestrians, but please watch your surroundings when crossing the roadway,” and may include any message that notifies pedestrians of the constraints to pay attention to their surroundings when crossing the roadway. Alternatively, the “third information” may include, but is not limited to, a message such as, for example, “An automated driving vehicle is approaching. For safety reasons, please wait until the automated driving vehicle has passed before crossing the roadway,” and may include any message notifying pedestrians of the constraints to refrain from crossing the roadway until the automated driving vehicle has passed.

Also, the control unit 25 notifies the driving assistant of each vehicle 10 of which the remaining time is less than the first threshold value of the second information, by sending a request for notification of the second information to the information processing device 30 via the communication unit 21. In response to receiving the notification request, the control unit 33 of the information processing device 30 notifies each driving assistant of the second information, by transmitting the second information to each vehicle 10 of which the remaining time is less than the first threshold value, or to each terminal device used by each driving assistant. That is to say, in the present embodiment, the roadside device 20 and the information processing device 30 cooperate to notify the driving assistant of each vehicle 10 of which the remaining time is less than the first threshold value, of the second information.

As described above, upon detecting a pedestrian heading towards the roadway, the roadside device 20 according to the present embodiment notifies the pedestrian of the first information indicating that the pedestrian can cross the roadway, based on the conditions of the roadway. After notification of the first information, the roadside device 20 then notifies the driving assistant of a relevant vehicle 10, which is the vehicle 10 approaching itself (the roadside device 20), of second information indicating presence of the pedestrian.

According to this configuration, the second information indicating the presence of the pedestrian is notified to the driving assistant after the timing at which the first information indicating that the roadway can be crossed is notified to the pedestrian (i.e., the timing at which there is sufficient time remaining before the automated driving vehicle passes the roadside device 20), as described above. Thus, the present embodiment improves the technology for providing traffic information assistance to relevant individuals with respect to the point that the certainty that the driving assistant will pay attention to the presence of a pedestrian attempting to cross the roadway is increased.

Although the present disclosure is described above based on the drawings and the embodiment, it should be noted that those skilled in the art may make various modifications and alterations thereto based on the present disclosure. Accordingly, it should therefore be understood that such modifications and alterations are within the scope of the present disclosure. For example, the functions and so forth included in the configurations, steps, and so forth, can be rearranged insofar as not logically inconsistent, and multiple configurations, steps, and so forth, may be combined into one, or divided.

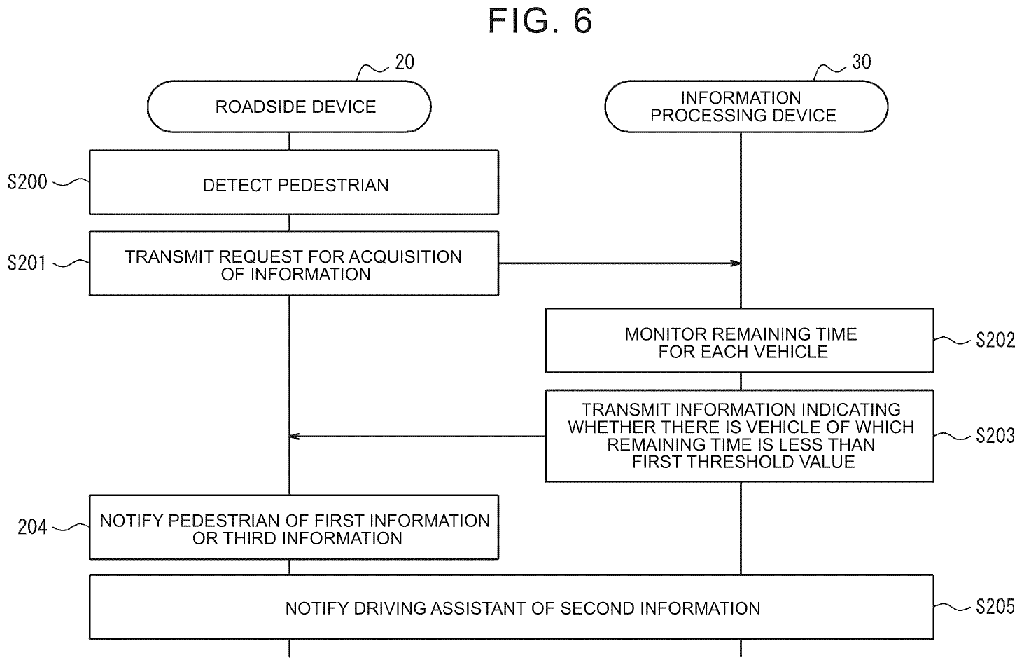

For example, an embodiment can also be made in which some of the operations executed by the roadside device 20 in the above-described embodiment are executed by the information processing device 30. A modification of the embodiment, in which some of the operations are executed by the information processing device 30, will be described with reference to FIG. 6.

In S200, the control unit 25 of the roadside device 20 detects, from video shot by the shooting unit 22, a pedestrian heading toward the roadway. This operation of S200 is the same as that of S100 in the above-described embodiment.

In S201, the control unit 25 transmits a request for acquisition of information indicating whether a vehicle 10, of which the remaining time until passing itself (the roadside device 20) is less than the first threshold value, is present on the roadway, to the information processing device 30 via the communication unit 21.

In S202, the control unit 33 of the information processing device 30 receives the acquisition request in S201 from the roadside device 20, whereby the control unit 33 monitors the remaining time for each vehicle 10 approaching the roadside device 20 until passing the roadside device 20. This operation of S202 is the same as that of S101 in the above-described embodiment.

In S203, the control unit 33 determines whether there is at least one vehicle 10 of which the remaining time is less than the first threshold value. This operation of S203 is the same as that of S102 in the above-described embodiment. Based on the determination result, the control unit 33 also transmits information indicating whether there is a vehicle 10 of which the remaining time is less than the first threshold value to the roadside device 20 via the communication unit 31.

In S204, upon receiving the information in S203, from the information processing device 30, the control unit 25 of the roadside device 20 notifies the pedestrian via the notification unit 23 of either the first information indicating that the roadway can be crossed, or the third information indicating constraints regarding crossing the roadway, depending on whether there is a vehicle 10 of which the remaining time is less than the first threshold value.

Specifically, when there is no vehicle 10 of which the remaining time is less than the first threshold value, the control unit 25 notifies the pedestrian of the first information. On the other hand, when there is a vehicle 10 of which the remaining time is less than the first threshold value, the control unit 25 notifies the pedestrian of the third information. The operation of notification of the first information or the third information in S204 is the same as that in S103 or S106 in the above-described embodiment.

In S205, the roadside device 20 and the information processing device 30 cooperate to notify the driving assistant of the relevant vehicle 10, which is the vehicle 10 approaching the roadside device 20, of the second information indicating the presence of the pedestrian.

Note that when the first information has been notified to the pedestrian in the immediately-preceding S204, the second information will be notified to the driving assistant in S205 when the remaining time for the relevant vehicle 10 reaches the second threshold value. The operations of notifying the second information when the remaining time for the relevant vehicle 10 reaches the second threshold value are the same as those in S104 and S105 in the above-described embodiment.

On the other hand, when the third information has been notified to the pedestrian in the immediately-preceding S204, the second information is immediately notified to the driving assistant in S205. The operation of immediately notifying the second information is the same as that in S106 in the above-described embodiment.

According to this modification, the second information indicating the presence of a pedestrian is notified to the driving assistant after the timing at which the first information indicating that the roadway can be crossed is notified to the pedestrian (i.e., the timing at which there is sufficient time remaining before the automated driving vehicle passes the roadside device 20), in the same way as the embodiment described above. Thus, according to this modification, technology for providing traffic information assistance to a relevant individual is improved with respect to the point that the certainty that the driving assistant will pay attention to the presence of the pedestrian attempting to cross the roadway is increased, in the same way as the embodiment described above.

An embodiment can also be made in which, for example, a general-purpose computer functions as the information processing device 30 according to the above embodiment. Specifically, a program describing processing contents for realizing each function of the information processing device 30 according to the above-described embodiment is stored in memory of the computer, and the program is read out and executed by a processor of the computer. Accordingly, the present disclosure can also be implemented as a program that is executable by the processor or a non-transitory computer-readable medium that stores the program.

What is claimed is:

1. A roadside device comprising:
a communication unit;
a shooting unit;
a notification unit; and
a control unit, wherein the control unit is configured to execute notifying a pedestrian of first information based on conditions of a roadway, via the notification unit, when the pedestrian heading toward the roadway is detected from video of the shooting unit, the first information being information indicating that the roadway is crossable, and
after the notification of the first information, notifying second information to a driving assistant of a relevant vehicle, that is an automated driving vehicle approaching the roadside device, via the communication unit, the second information being information indicating presence of the pedestrian.

2. The roadside device according to claim 1, wherein:
the control unit is configured to, upon detecting the pedestrian from the video, notify the pedestrian of the first information, when a predetermined automated driving vehicle is not present on the roadway; and
the predetermined automated driving vehicle is a vehicle of which remaining time until passing the roadside device is less than a first threshold value.

3. The roadside device according to claim 2, wherein:
the control unit is configured to notify the pedestrian of third information via the notification unit when the predetermined automated driving vehicle is present on the roadway; and
the third information is information indicating constraints regarding crossing the roadway.

4. The roadside device according to claim 2, wherein the control unit is configured to execute
monitoring the remaining time for each automated driving vehicle approaching the roadside device, and
when the remaining time for an automated driving vehicle reaches a second threshold value that is less than the first threshold value, deciding the automated driving vehicle to be the relevant vehicle.

5. The roadside device according to claim 4, wherein the control unit is configured to execute
estimating a traveling route of the automated driving vehicle, based on changes in positions of automated driving vehicles present on the roadway, and map information, and
monitoring the remaining time for each automated driving vehicle regarding which the roadside device is installed on the traveling route.

6. The roadside device according to claim 4, wherein the control unit is configured to execute
acquiring information indicating a traveling route of each automated driving vehicle present on the roadway from an information processing device via the communication unit, and
monitoring the remaining time for each automated driving vehicle regarding which the roadside device is installed on the traveling route.

7. The roadside device according to claim 2, wherein:
the control unit is configured to execute
transmitting a request for acquiring fourth information to an information processing device via the communication unit, when the pedestrian is detected from the video, and
receiving the fourth information from the information processing device via the communication unit; and
the fourth information is information indicating whether the predetermined automated driving vehicle is present on the roadway.

8. A method executed by a roadside device including a communication unit, a shooting unit, and a notification unit, the method comprising:
notifying a pedestrian of first information based on conditions of a roadway, via the notification unit, when the pedestrian heading toward the roadway is detected from video of the shooting unit, the first information being information indicating that the roadway is crossable; and
after the notification of the first information, notifying second information to a driving assistant of a relevant vehicle, that is an automated driving vehicle approaching the roadside device, via the communication unit, the second information is information indicating presence of the pedestrian.

9. The method according to claim 8, wherein:
upon the pedestrian being detected from the video, the roadside device notifies the pedestrian of the first information when a predetermined automated driving vehicle is not present on the roadway; and
the predetermined automated driving vehicle is a vehicle of which remaining time until passing the roadside device is less than a first threshold value.

10. The method according to claim 9, further comprising notifying third information to the pedestrian via the notification unit when the predetermined automated driving vehicle is present on the roadway, wherein
the third information is information indicating constraints regarding crossing the roadway.

11. The method according to claim 9, further comprising:
monitoring the remaining time for each automated driving vehicle approaching the roadside device; and
deciding an automated driving vehicle to be the relevant vehicle when the remaining time for the automated driving vehicle reaches a second threshold value that is less than the first threshold value.

12. The method according to claim 11, further comprising:
estimating a traveling route of the automated driving vehicle, based on changes in positions of automated driving vehicles present on the roadway, and map information; and
monitoring, by the roadside device, the remaining time for each automated driving vehicle regarding which the roadside device is installed on the traveling route.

13. The method according to claim 11, further comprising:
acquiring information indicating a traveling route of each automated driving vehicle present on the roadway from an information processing device via the communication unit; and
monitoring, by the roadside device, the remaining time for each automated driving vehicle regarding which the roadside device is installed on the traveling route.

14. The method according to claim 9, further comprising:
transmitting a request for acquisition of information indicating whether the predetermined automated driving vehicle is present on the roadway, to an information processing device via the communication unit, when the pedestrian is detected from the video; and
receiving the information from the information processing device via the communication unit.

15. A control system comprising:
a roadside device including a shooting unit and a notification unit; and
an information processing device that is communicable with the roadside device, wherein the roadside device is configured to execute
notifying a pedestrian of first information via the notification unit, based on conditions of a roadway, when the pedestrian heading toward the roadway is detected from video of the shooting unit, the first information being information indicating that the roadway is crossable, and
after the notification of the first information, notifying second information to a driving assistant of a relevant vehicle, that is an automated driving vehicle approaching the roadside device, via the information processing device, the second information being information indicating presence of the pedestrian.

16. The control system according to claim 15, wherein:
the roadside device is configured to, upon detecting the pedestrian from the video, notify the pedestrian of the first information, when a predetermined automated driving vehicle is not present on the roadway; and
the predetermined automated driving vehicle is a vehicle of which remaining time until passing the roadside device is less than a first threshold value.

17. The control system according to claim 16, wherein:
the roadside device is configured to notify the pedestrian of third information via the notification unit when the predetermined automated driving vehicle is present on the roadway; and
the third information is information indicating constraints regarding crossing the roadway.

18. The control system according to claim 16, wherein the roadside device or the information processing device is configured to execute
monitoring the remaining time for each automated driving vehicle approaching the roadside device, and
when the remaining time for an automated driving vehicle reaches a second threshold value that is less than the first threshold value, deciding the automated driving vehicle to be the relevant vehicle.

19. The control system according to claim 18, wherein the roadside device or the information processing device is configured to execute
estimating a traveling route of the automated driving vehicle, based on changes in positions of automated driving vehicles present on the roadway, and map information, and
monitoring the remaining time for each automated driving vehicle regarding which the roadside device is installed on the traveling route.

20. The control system according to claim 16, wherein:
the roadside device is configured to transmit a request for acquiring fourth information to the information processing device, when the pedestrian is detected from the video;
the information processing device is configured to transmit the information to the roadside device in response to receiving the acquisition request; and
the fourth information is information indicating whether the predetermined automated driving vehicle is present on the roadway.
